(19) United States
(12) Patent Application Publication
(10) Pub. No.: US 2011/0036997 A1
(43) Pub. Date: Feb. 17, 2011

(54) ULTRAVIOLET EQUIPMENT

(75) Inventor: Chien Fong LAI, Taoyuan County (TW)

Correspondence Address: EAST RICH ENTERPRISE CO., LTD, 11F.-2, NO. 107, NANFU ST., LUJHU TOWNSHIP, TAOYUAN COUNTY, 338, TW

(73) Assignee: EAST RICH ENTERPRISE CO., LTD., Taoyuan County (TW)

(21) Appl. No.: 12/541,169

(22) Filed: Aug. 14, 2009

(51) Int. Cl. B01J 19/12

(52) U.S. Cl. 250/492.1

(57) ABSTRACT

The present invention relates to an UV equipment, which enables LED unit to generate UV radiation onto a gel, which is cured after a period of time and then applied to fabrication of pseudo-nail; if the gel is applied to fabrication of pseudo-nail, it's possible to attach it closely to the real nail; if the gel is applied to tooth mould or pseudo-tooth, a protective layer will be formed from gel curing and covered onto the surface of the tooth mould or pseudo-tooth.

### BACKGROUND OF THE INVENTION

The present invention relates generally to an ultraviolet (UV) equipment, and more particularly to an innovative one which generates UV radiation by LED in lieu of UV lamp, and also applies ultraviolet onto a gel for curing purpose.

An UV equipment 1 used for pseudo-nail gel (e.g.: UV gel, UV resin) generally applies a lamp 11 to yield radiation of UV wavelength for the curing of UV gel or UV resin, as shown in FIG. 1. The typical UV equipment 1 can realize the curing of the UV gel or UV resin, but there are still some shortcomings: 1: the lamp 11 in a radiation state will surely generate heat source; since the lamp 11 is mounted in the UV equipment 1, the heat source generated by the lamp 11 is difficult to be dispersed, leading to overheating or poor heat elimination; 2, the lamp 11 generates light in a radiative way, so when the lamp 11 radiates onto the UV gel or UV resin, the curing time is longer and effect is poorer; in the event of incomplete curing, a longer radiation time will be required, leading to waste of both time and electrical resources, along with higher electricity price; 3, when the lamp 11 is activated, it's difficult to control efficiently the curing time of the UV gel or UV resin; 4, the lamp 11 has a shorter service life, so new product are often purchased with a relatively higher cost; for these reasons, more efforts have to be made for resolving the aforementioned problems.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The primary objective of the UV equipment of the present invention is to replace conventional lamp by LED units, since the heat source generated by LED units is much less than that of lamp, making it possible to reduce the heat source and resolve the heat elimination problem.

The second objective of the UV equipment of the present invention is that the light path of LED units is concentrated, so the curing effect of UV gel or UV resin is better, helping to save power and reduce the electricity price.

The third objective of the UV equipment of the present invention is that the UV path of LED units is concentrated, enabling to control efficiently the curing time of UV gel or UV resin and avoid incomplete curing.

The fourth objective of the UV equipment of the present invention is that the replacement frequency and cost of the units are relatively lower thanks to the longer service life of the LED units.

The UV equipment of the present invention is mainly characterized by that, the LED units are used for radiation of UV wavelength onto a gel, which is cured after a period of reaction; if the gel is applied to pseudo-nail, it's possible to attach it closely to the real nail; if the gel is applied to tooth mould or pseudo-tooth, a protective layer will be formed from gel curing and covered onto the surface of the tooth mould or pseudo-tooth.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows a schematic view of a typical equipment.

FIG. 2 shows a schematic view of the first preferred embodiment of UV equipment of the present invention.

FIGS. 3, 4 show a schematic view of the second preferred embodiment of UV equipment of the present invention.

FIGS. 5, 6 show a schematic view of the third preferred embodiment of UV equipment of the present invention.

FIGS. 7, 8 show a schematic view of the fourth preferred embodiment of UV equipment of the present invention.

FIGS. 9, 10, 11, 12, 13, 14 show a schematic view of the fifth preferred embodiment of UV equipment of the present invention.

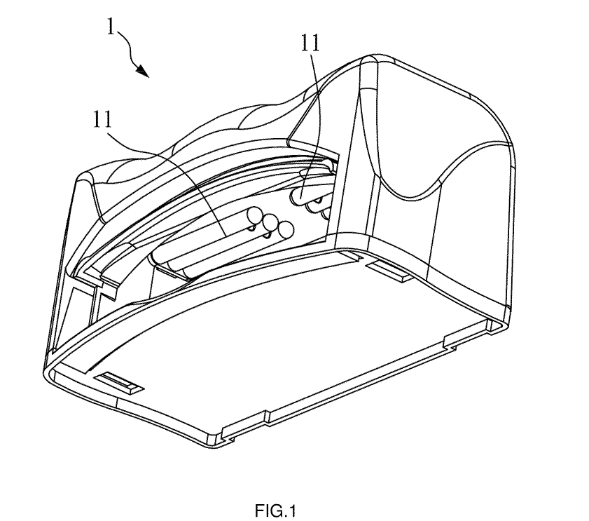

### DETAILED DESCRIPTION OF THE INVENTION

### Preferred Embodiment 1

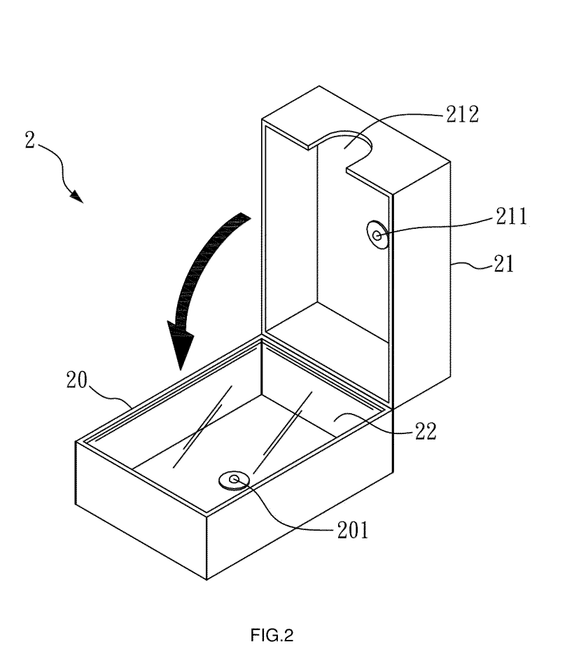

Referring to FIG. 2—a schematic view of the first preferred embodiment of UV equipment of the present invention, wherein the equipment 2 comprising:

a basement 20, at bottom of which at least a LED unit 201 is arranged; and the LED unit 201 is enabled for radiation of UV wavelength;

a cover 21, at top of which at least a LED unit 201 is arranged; and the LED unit 201 is enabled for radiation of UV wavelength;

a glass substrate 22, which is configured on the basement 20 or cover 21 far away from one side of the LED units 201, 211.

Of which, the power supply of the LED units 201, 211 is sourced from a battery, DC or AC.

Of which, there is available with UVA, UVB or UVC.

A notch 212 is formed at frontal edge of the basement 20 or cover 21.

When the nail of the user is covered by gel and preparatory procedure for pseudo-nail is completed, the gel-coated position is placed on the LED units 201, 211 of the basement 20 and cover 21, and then the cover 21 is covered onto the basement 20, next the LED units 201, 211 are energized for UV radiation onto the gel, which is cured after a period of reaction; the curing of gel can be accelerated by the upper and lower LED units 201, 211.

When UV gel or UV resin is coated after completion of the preparatory work for tooth mould or pseudo-tooth, the curing reaction can be conducted through the equipment 2 of the preferred embodiment 1.

### Preferred Embodiment 2

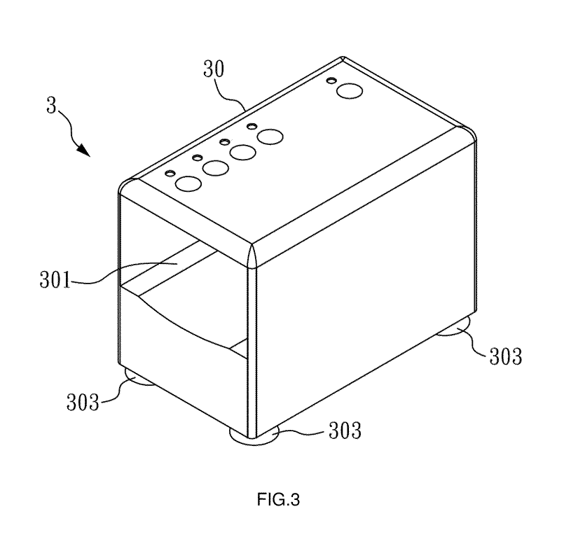

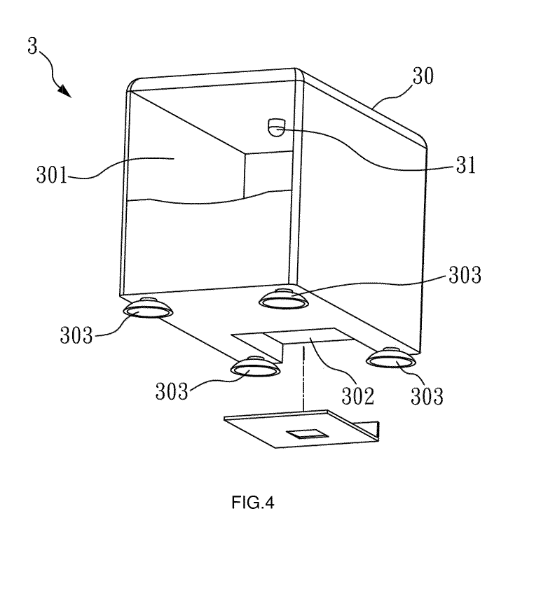

Referring to FIGS. 3, 4—a schematic view of the second preferred embodiment of UV equipment of the present invention, wherein the equipment 3 comprising:

a main body 30, which includes a radiation room 301; at least a LED unit 31 is arranged on the top of the radiation room 301;

at least a LED unit 31, which is arranged at top of the radiation room 301 of the main body 30, and enabled for radiation of UV wavelength.

The main body 30 also includes a battery room 302.

Of which, the power supply of the LED units 31 is sourced from a battery, DC or AC.

Of which, there is available with UVA, UVB or UVC.

Furthermore, the main body 30 includes sucking discs 303, which are distributed at four corners at the bottom of the main body 30, and can be attached onto a working plane for retaining reliably the main body 30.

The main body 30 also includes a control circuit, which is used to start/close the equipment 3 and set the radiation time interval of LED unit 31.

When the nail of the user is covered by gel and preparatory procedure for pseudo-nail is completed, the gel-coated position is inserted into the radiation room 301 of the main body 30, and placed with the coverage of the LED unit 31, next the LED unit 31 is energized for UV radiation onto the gel, which is cured after a period of reaction.

When UV gel or UV resin is coated after completion of the preparatory work for tooth mould or pseudo-tooth, the curing reaction can be conducted through the equipment 3 of the preferred embodiment 2.

### Preferred Embodiment 3

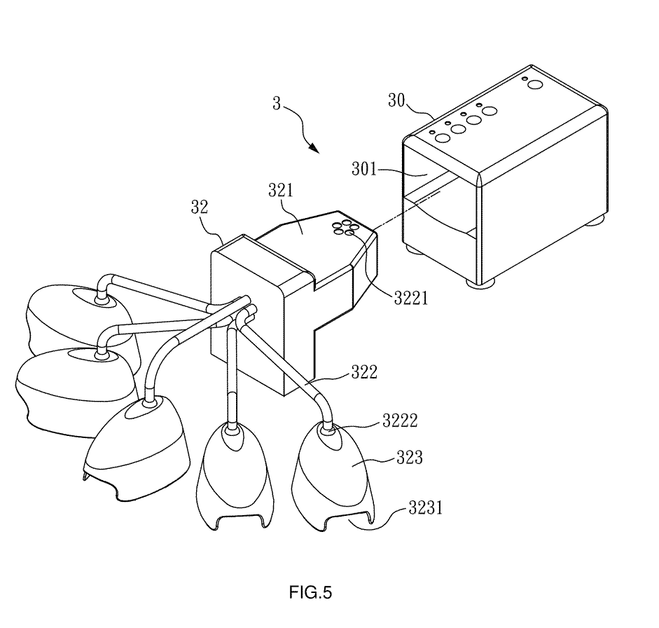

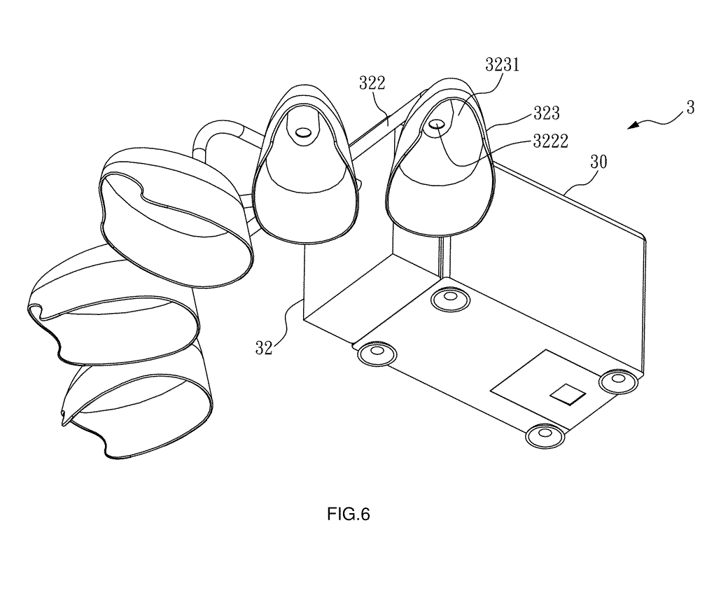

Referring to FIGS. 5, 6—a schematic view of the third preferred embodiment of UV equipment of the present invention, wherein the equipment 3 comprises the following parts in addition to those contained in the second preferred embodiment 2:

a hanging unit 32, which can be mated with the radiation room 301 of the main body 30;

Of which, the hanging unit 32 includes:

a socket 321;

at least an optical fibre 322, which is partially covered by the socket 321; one end 3221 of the optical fibre 322 is fixed on the surface of the socket 321, and the other end 3222 linked to the cover 323;

at least a cover 323, which is linked to the other end 3222 of the optical fibre 322, and an arched notch 3231 is formed at the frontal edge of the cover 323.

The socket 321 of the hanging unit 32 is inserted into the radiation room 301 of the main body 30 of the equipment 3, and the LED unit 31 within the radiation room 301 is aligned with one end 3221 of the optical fibre 322 on the surface of the socket 321 of the hanging unit 32. When the nail of the user is covered by gel and preparatory procedure for pseudo-nail is completed, the gel-coated position is covered by the cover 323 of the hanging unit 32, and then the LED unit 31 of equipment 3 is energized for UV radiation. At the same time, with the help of one end 3221 of the optical fibre 322 of the hanging unit 32, UV is guided to the other end 3222 of the optical fibre 322 and applied onto the gel, which is cured after a period of reaction.

When UV gel or UV resin is coated after completion of the preparatory work for tooth mould or pseudo-tooth, the curing reaction can be conducted through the equipment 3 of the preferred embodiment 3.

### Preferred Embodiment 4

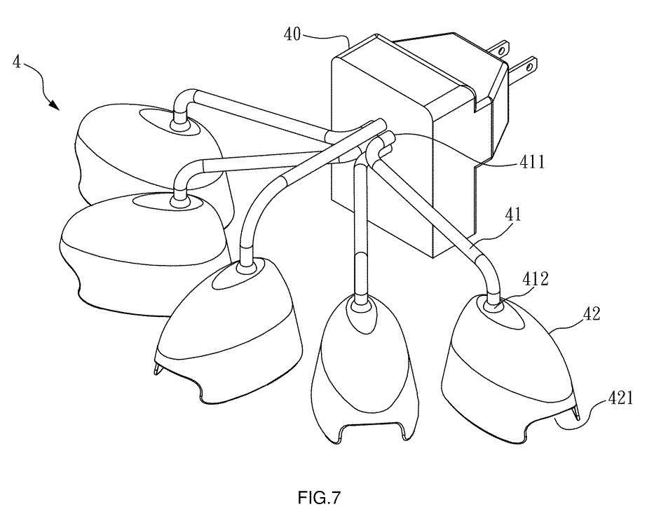

Referring to FIGS. 7, 8—a schematic view of the fourth preferred embodiment of UV equipment of the present invention, wherein the equipment 4 comprising:

a main body 40;

at least a wire 41, one end 411 of which is extended into the main body 40, and the other end 412 linked to the cover 42;

at least a cover 42, which is linked to the other end 412 of the wire 41, and an arched notch 421 is formed at the frontal edge of the cover 42;

At least a LED unit 43, which is mounted into the cover 42, and electrically connected with the wire 41 for radiation of UV wavelength.

The main body 40 also includes a battery room, which is electrically connected with at least a wire 41.

Of which, the power supply of the LED units 43 is sourced from a battery, DC or AC.

Of which, there is available with UVA, UVB or UVC.

Furthermore, the main body 40 refers to a socket that is electrically connected with at least a wire 41.

When the nail of the user is covered by gel and preparatory procedure for pseudo-nail is completed, the gel-coated position is covered by the cover 42 of the equipment 4, and then the LED unit 43 of the equipment 4 is energized for UV radiation onto the gel, which is cured after a period of reaction.

When UV gel or UV resin is coated after completion of the preparatory work for tooth mould or pseudo-tooth, the curing reaction can be conducted through the equipment 4 of the preferred embodiment 4.

### Preferred Embodiment 5

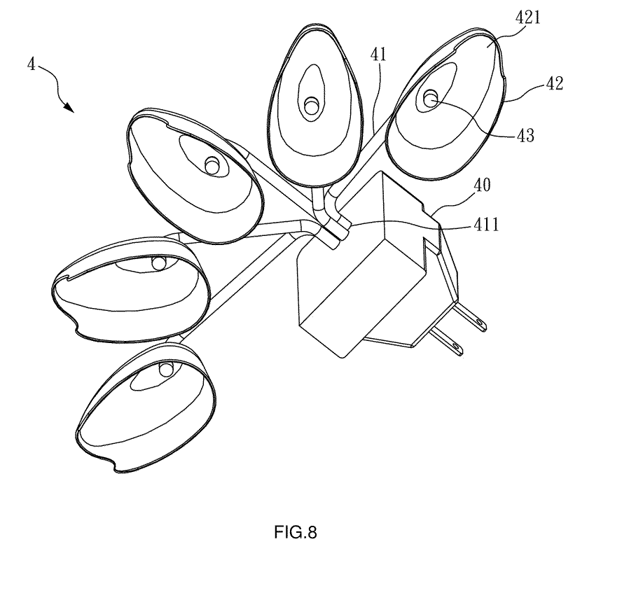

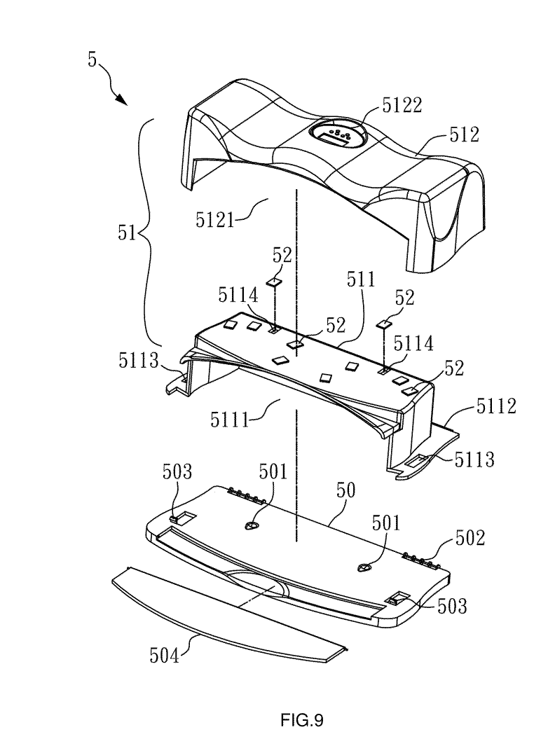

Referring to FIGS. 9-14—a schematic view of the fifth preferred embodiment of UV equipment of the present invention, wherein the equipment 5 comprising: a basement 50, cover 51, control circuit 52 and LED unit 53; the cover 51 is composed of internal groove 511 and outer casing 512, and can be linked to the basement 50 via the internal groove 511 or outer casing 512; the control circuit 52 is assembled within a space after the internal groove 511 and outer casing 512 are coupled; the LED unit 53 is placed at top of the internal groove 511, and electrically connected with the control circuit 52.

A locating point 501 is set on the surface of the basement 50, and used for locating of the users' hands or feet, so that the intended curing range of the gel is within the range of the light source.

Of which, open ends 5111, 5121 are set correspondingly at the front of the internal groove 511 and outer casing 512 of the cover 51 for insertion of the hands or feet.

Linkable hinge mechanisms 5112, 502 are arranged at the rear side of the internal groove 511 of the basement 50 and the cover 51, a fastener 503 is placed at the lateral flanges of the basement 50, and a snapping hole 5113 is placed at the lateral flanges of the internal groove 511 for snapping or disengagement, so as to close or open the cover 51 in relation to the basement 50.

Of which, a control panel 5122 is placed on the outer casing 512 and electrically connected with the control circuit 52; this control panel 5122 can control the on/off of the equipment 5, and also set the radiation time; moreover, the equipment 5 is suitable for the power supply modes such as battery, AC or DC.

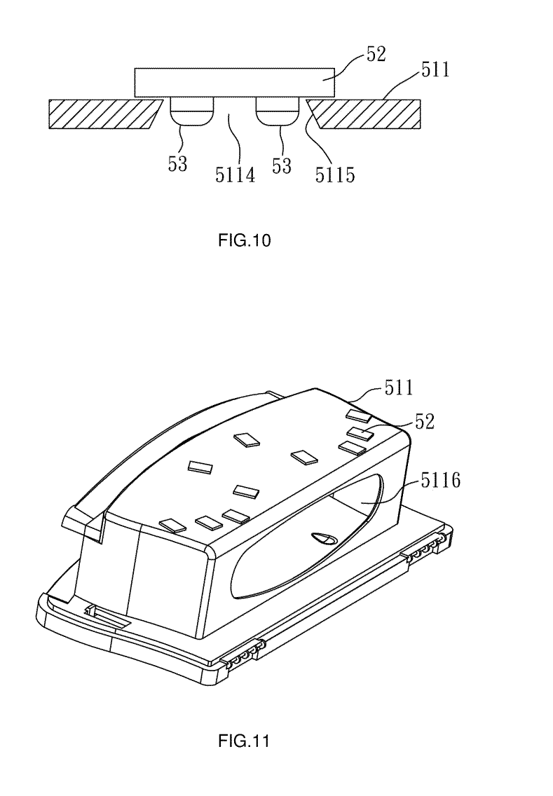

Referring to FIGS. 9, 10, the equipment 5 is provided with radiative openings 5114 at the top of the internal groove 511 of the cover 51; the openings 5114 are of an oblique surface 5115 for increasing the radiation range of the light source.

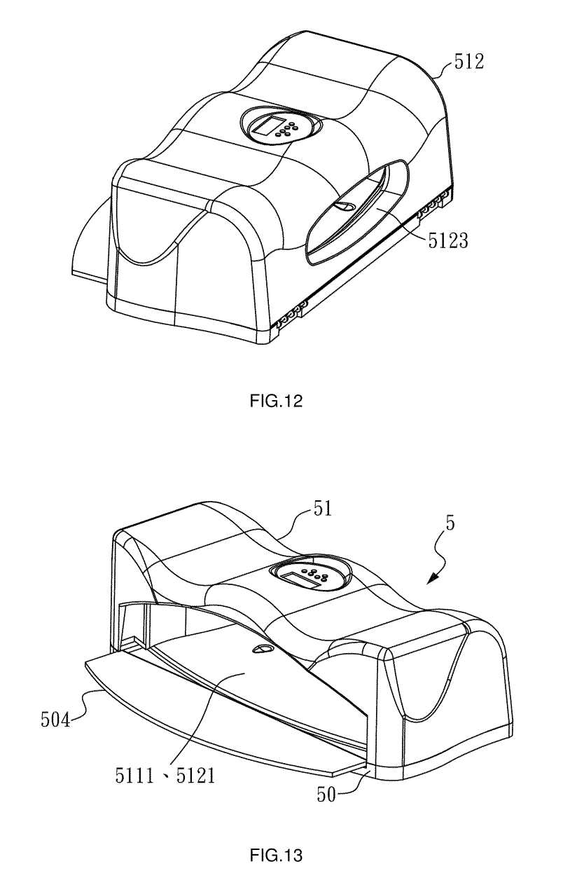

Referring to FIGS. 10, 11, the radiative openings 5114 at top of the internal groove 511 are set for assembly of the control circuit 52 and LED unit 53. Of which, a sight opening 5116 is arranged at the rear side of the internal groove 511; referring also to FIG. 12, at the rear side of the outer casing 512, an inspection window 5123 is arranged correspondingly to the sight opening 5116 of the internal groove 511, allowing to view clearly the locating, utilization or curing of the hands or the feet.

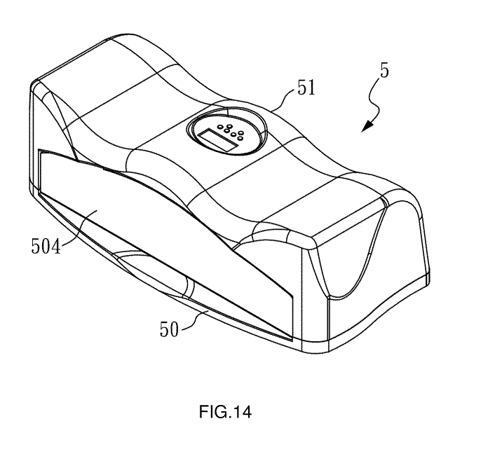

Referring to FIG. 13, a moveable ornamental plate 504 is pivoted on the frontal edge of the basement 50 of the equipment 5; when the equipment 5 is used, this ornamental plate 504 can be opened and disengaged from the open ends 5111, 5121 of the cover 51; after completion of operation, the ornamental plate 504 is sealed onto the open ends 5111, 5121 of the cover 51, so as to reduce the infiltration of powder into the equipment 5 as shown in FIG. 14.

Of which, there is available with UVA, UVB or UVC.

On the whole, the UV equipment of the present invention can really achieve the aforementioned efficacy via the preferred embodiments thereof, and the novelty and inventive steps aren't made publicly available before filing an application.

Although the invention has been explained in relation to its preferred embodiment, it is to be understood that many other possible modifications and variations can be made without departing from the spirit and scope of the invention as hereinafter claimed.

I claim:

1. An UV equipment, which comprising:
A basement, at bottom of which at least a LED unit is arranged; and the LED unit is enabled for radiation of UV wavelength;
a cover, at top of which at least a LED unit is arranged; and the LED unit is enabled for radiation of UV wavelength;
a glass substrate, which is configured on the basement.

2. The structure defined in claim 1, wherein the power supply of the LED unit is sourced from a battery, DC or AC.

3. The structure defined in claim 1, wherein there is available with UVA, UVB or UVC.

4. The structure defined in claim 1, wherein a notch is formed at frontal edge of the basement or cover.

5. An UV equipment, which comprising:
a main body, which includes a radiation room; at least a LED unit is arranged on the top of the radiation room;
at least a LED unit, which is arranged at top of the radiation room of the main body, and enabled for radiation of UV wavelength.

6. The structure defined in claim 5, wherein the main body also includes a battery room.

7. The structure defined in claim 5, wherein the power supply of the LED unit is sourced from a battery, DC or AC.

8. The structure defined in claim 5, wherein there is available with UVA, UVB or UVC.

9. The structure defined in claim 5, wherein the main body includes sucking discs, which are distributed at four corners at the bottom of the main body.

10. The structure defined in claim 5, wherein the main body also includes a control circuit, which is used to start/close the equipment and set the radiation time interval of LED unit.

11. The structure defined in claim 5, wherein the equipment also comprising:
a hanging unit, which can be mated with the radiation room of the main body.

12. The structure defined in claim 11, wherein the hanging unit comprising:
a socket;
at least an optical fibre, which is partially covered by the socket; one end of the optical fibre is fixed on the surface of the socket, and the other end linked to the cover;
at least a cover, which is linked to the other end of the optical fibre, and an arched notch is formed at the frontal edge of the cover.

13. An UV equipment, which comprising:
a main body;
at least a wire, one end of which is extended into the main body, and the other end linked to the cover;
at least a cover, which is linked to the other end of the wire, and an arched notch is formed at the frontal edge of the cover;
at least a LED unit, which is mounted into the cover, and electrically connected with the wire for radiation of UV wavelength.

14. The structure defined in claim 13, wherein the main body also includes a battery room, which is electrically connected with at least a wire.

15. The structure defined in claim 13, wherein the power supply of the LED units is sourced from a battery, DC or AC.

16. The structure defined in claim 13, wherein there is available with UVA, UVB or UVC.

17. The structure defined in claim 13, wherein the main body refers to a socket that is electrically connected with at least a wire.

18. An UV equipment, which comprising:
a basement;
a cover, the cover is composed of internal groove and outer casing, and can be linked to the basement via the internal groove or outer casing;
at least a control circuit, which is assembled within a space after the internal groove and outer casing are coupled; and
at least a LED unit, which is placed at top of the internal groove, and electrically connected with the control circuit for radiation of UV wavelength.

19. The structure defined in claim 18, wherein at least a locating point is set on the surface of the basement.

20. The structure defined in claim 18, wherein a fastener is placed at the lateral flanges of the basement.

21. The structure defined in claim 18, wherein a snapping hole is placed at the lateral flanges of the internal groove.

22. The structure defined in claim 18, wherein radiative openings are set at top of the internal groove.

23. The structure defined in claim 22, wherein the openings are of an oblique surface.

24. The structure defined in claim 18, wherein an open end is formed at frontal edge of the internal groove and outer casing of the cover.

25. The structure defined in claim 18, wherein hinge mechanisms are arranged at the rear side of the internal groove or outer casing of the basement or the cover.

26. The structure defined in claim 18, wherein there is available with UVA, UVB or UVC.

27. The structure defined in claim 18, wherein a control panel is placed on the outer casing of the cover and electrically connected with the control circuit.

28. The structure defined in claim 18, wherein a moveable ornamental plate is pivoted on the frontal edge of the basement.

29. The structure defined in claim 18, wherein a sight opening is arranged on the internal groove of the cover.

30. The structure defined in claim 18, wherein an inspection window is arranged on the outer casing of the cover.
